(19) United States
(12) Patent Application Publication
(10) Pub. No.: US 2007/0101681 A1
(43) Pub. Date: May 10, 2007

(54) Method for manufacturing contents contained in a container

(75) Inventors: Takeshi Iwashita, Yokohama-shi (JP); Shigeru Sakai, Yokohama-shi (JP); Makoto Sawada, Yokohama-shi (JP); Chikako Sunohara, Yokohama-shi (JP)

Correspondence Address: HEDMAN & COSTIGAN P.C., 1185 AVENUE OF THE AMERICAS, NEW YORK, NY, 10036, US

(73) Assignee: Toyo Seikan Kaisha, Ltd.

(21) Appl. No.: 11/270,301

(22) Filed: Nov. 9, 2005

(51) Int. Cl. B65B 55/02; B67B 3/28

(52) U.S. Cl. 53/425; 53/471

(57) ABSTRACT

A method for manufacturing contents such as a drink contained in a container such as a PET bottle by filling the contents in the container, sealing the container and sterilizing the container includes steps of: filling the contents in a polyester container having a non-crystallized neck portion; sealing the container; and sterilizing the container in such a manner that temperature of the neck portion of the container during sterilization is maintained within a temperature range which is 61° C. or over and less than a glass transition temperature determined by moisture content of the container.

### BACKGROUND OF THE INVENTION

This invention relates to a method for manufacturing contents contained in a container and, more particularly, to a method for manufacturing drink bottled in a polyester bottle having a non-crystallized neck portion.

Known in the art of a method for manufacturing drink bottled in a PET bottle is a method called hot-pack. Japanese Patent Application Laid-open Publication Nos. 2001-278225 and Hei 8-309841 disclose examples of hot-pack.

According to this method, acid drink having pH of less than 4.6 or low-acid drink having pH of 4.6 or over which is heated to 85° C. to 95° C. is filled in a PET bottle which is imparted with a heat resisting property by crystallizing its neck portion and, after sealing the bottle, the bottle is laid sideways to cause the hot drink filled in the bottle to come into contact with the neck and cap inner surface portions of the bottle and thereby sterilize the neck and cap inner surface portions, and then the bottle is cooled by a cooling pasteurizer to provide the bottled drink as a product.

As described above, according to hot-pack, drink is filled in a PET bottle at a high filling temperature of 85-95° C. and, therefore, as the PET bottle for this purpose, a PET bottle having a crystallized neck portion and therefore having sufficient heat resisting property in this portion must be used and a PET bottle having a non-crystallized neck portion cannot be used. Since a PET bottle having a crystallized neck portion is generally more expensive than a PET bottle having a non-crystallized neck portion, hot-pack is disadvantageous in the cost of manufacture of acid or low-acid drinks bottled in a PET bottle.

Further, hot-pack which requires a high filling temperature consumes a large energy and, moreover, since the bottle has a high temperature when it is cooled by a cooling pasteurizer after sterilization of the bottle, a long cooling period is required. This is disadvantageous for production efficiency and requires further energy consumption.

It is therefore a first object of the invention to provide a method for manufacturing contents contained in a container which will obviate use of a polyester container such as a PET bottle having a crystallized neck portion.

It is a second object of the invention to provide a method for manufacturing contents contained in a container which requires less time in cooling than hot-pack whereby production efficiency is improved and energy is saved.

### SUMMARY OF THE INVENTION

For achieving these objects of the invention, the inventors of the present invention have conducted studies and experiments which have resulted in the finding, which has led to the present invention, that by filling contents such as a drink in a polyester container such as a PET bottle having a non-crystallized neck portion and, after sealing the container, sterilizing the container in such a manner that temperature of the neck portion of the container during sterilization is maintained within a temperature range which is 61° C. or over and less than a glass transition temperature determined by moisture content of the container, a commercially sufficient degree of sterilization can be achieved even at a filling temperature within a temperature range which is below the filling temperature of 85-95° C. by the conventional hot-pack.

For achieving the above described objects of the invention, there is provided a method for manufacturing contents contained in a container by filling the contents in the container, sealing the container and sterilizing the container comprising steps of:

filling the contents in a polyester container having a non-crystallized neck portion;

sealing the container; and

sterilizing the container in such a manner that temperature of the neck portion of the container during sterilization is maintained within a temperature range which is 61° C. or over and less than a glass transition temperature determined by moisture content of the container.

According to the invention, by filling contents in a container at a temperature within a temperature range which is 61° C. or over and less than a glass transition temperature determined by moisture content of the container, and sterilizing the container at this temperature, a commercially sufficient degree of sterilization can be achieved and, therefore, a polyester container having a non-crystallized neck portion whose glass transition temperature is within this temperature range can be used. Moreover, since the filling temperature can be made substantially lower than the conventional hot-pack, energy consumption can be substantially reduced and time required for cooling after the sterilization can be saved, with the result that production efficiency can be remarkably improved.

In one aspect of the invention, the method further comprises a step of cooling the container after sterilization of the container.

In another aspect of the invention, the moisture content of the container is moisture content of the non-crystallized neck portion of the container.

In a method of producing a polyester container such as a PET bottle, a neck portion of the container which is substantially not-crystallized or not drawn is a portion which has the poorest heat resisting property of the container. Therefore, by sterilizing the container at a temperature which is less than the glass transition temperature determined by moisture content of the neck portion of the container, distortion of the neck portion of the container can be prevented. The same is the case with a polyester container such as a polyester cup which, in manufacturing, is substantially drawn but is not crystallized.

In another aspect of the invention, the filling of the contents in the container and the sealing of the container after the filling are performed in an outer environment controlled space. By this arrangement, achievement of aseptic condition by the sterilization of the container can be further enhanced and an aseptic condition of a degree which cannot be achieved by the sterilization of the container only can be achieved.

In another aspect of the invention, the sterilization of the container is performed by filling heated contents in the container, sealing the container and inclining the container to cause the heated contents to come into contact with the neck portion of the container. By inclining the container, the contents come into contact with the neck portion of the container whereby sterilization of the neck portion can be achieved more sufficiently. The inclination of the container includes laying the container sideways and turning the container upside down.

In another aspect of the invention, the sterilization of the container is performed by filling the contents in the container, sealing the container and causing hot water to come into contact with outer surface of the container. By causing hot water to come into contact with the outer surface of the container by means of, e.g., a hot water pasteurizer, sterilization of the container can be achieved more sufficiently.

In another aspect of the invention, the sterilization of the container is performed by filling the heated contents in the container, sealing the container, and inclining the container to cause the heated contents to come into contact with the neck portion of the container and also causing hot water to come into contact with outer surface of the container.

In another aspect of the invention, the method further comprises a step of reducing the moisture content of the container before filling the contents in the container.

There is correlation between glass transition temperature of a container such as a PET bottle and moisture content of the container, i.e., the lower the moisture content of the container, the higher is the glass transition temperature of the container. Therefore, when it is necessary to sterilize the container at a higher temperature to make more sufficient sterilization, it is sometimes necessary to reduce the moisture content of the container so as to increase the glass transition temperature of the container. In this aspect of the invention, by reducing the moisture content of the container, the glass transition temperature of the container can be increased to exceed a necessary sterilizing temperature.

In another aspect of the invention, the method further comprises steps of forming a preform of the container, and reducing moisture content of the preform before the preform is formed to the container. By reducing the moisture content of the preform of the container, the glass transition temperature of the container can be increased to a higher temperature than in a case where the moisture content of the container only is reduced.

The step of reducing the moisture content of the container and the container preform can be achieved preferably by removing moisture of the container and the preform. More specifically, removal of moisture of the container and preform can be achieved by means of a dehumidifier or, alternatively, by keeping the container and the preform in a moisture adjusting room such as a drying room.

In another aspect of the invention, after forming of the container, the formed container is transferred directly to the contents filling step. By this arrangement, time required from forming of the container to filling the contents can be shortened whereby the amount of moisture which the container absorbs from the environment is reduced and the moisture content of the container can be maintained at a low level to that extent.

In another aspect of the invention, the container is transferred directly to the filling step after forming of the container and the container is formed in an outer environment controlled space. By this arrangement, aseptic condition of the container can be further improved.

In another aspect of the invention, the method further comprises steps of forming a preform of the container, transferring the formed preform directly to a container forming step for forming the preform to the container, and transferring the formed container directly to the contents filling step.

In another aspect of the invention, the steps of forming of the preform, transferring of the preform to the container forming step and forming of the container are performed in an outer environment controlled space.

In another aspect of the invention, the outer environment controlled space is controlled to Class 100,000 or below.

In still another aspect of the invention, there is provided a polyester container used in the method of the present invention having a non-crystallized neck portion and having reduced internal pressure within a range from 0.35 KPa to 0.70 KPa at room temperature and under atmospheric pressure.

### BRIEF DESCRIPTION OF THE DRAWINGS

FIG. 1 is a flow chart showing an embodiment of the method according to the present invention;

FIG. 2 is a flow chart showing another embodiment of the method according to the present invention;

FIG. 3 is a flow chart showing still another embodiment of the method according to the present invention;

FIG. 4 is graph showing relationship between moisture content of the bottle and the glass transition temperature; and

FIG. 5 is a graph showing relationship between contents liquid filling temperature and internal pressure of the bottle.

### DESCRIPTION OF PREFERRED EMBODIMENTS

Description will now be made about preferred embodiments of the invention with reference to the accompanying drawings.

Containers used for the method of the present invention are polyester containers including polyester bottles such as PET bottles, and cups, trays and tubes etc. made of polyester. Contents contained in the polyester containers to which the method of the present invention is applied include drinks, food such as jam, seasonings, cosmetics and pharmaceuticals. Drinks to which the method of the present invention is suitably applied include acid drinks having pH of less than 4.6, low-acid drinks having pH of 4.6 or over, and mineral water. The acid drinks include fruit drinks, vegetable drinks, milk drinks, teas (lemon teas), functional soft drinks (sports drinks) and near water. The low-acid drinks include coffees and teas which do not contain milk, e.g., sugarless coffee, coffee with sugar, green tea, black tea and oolong tea.

In the method of the present invention, contents are filled in a polyester container having a non-crystallized neck portion, the container is sealed, and the container is sterilized in such a manner that temperature of the neck portion of the container during sterilization will be maintained within a temperature range which is 61° C. or over and less than a glass transition temperature determined by moisture content of the container.

The temperature of the neck portion of the container herein means a temperature at any place from the inside surface to the outside surface of the neck portion of the container. Particularly important are temperatures at the inside and outside surfaces of the neck portion and most particularly important are temperatures at the inside and outside surfaces of the neck portion in portions which come into contact with seal means. If there is a small gap between the inside and outside surfaces of the neck portion and the seal means, and sterilization is performed with liquid content remaining in this gap, there arises a problem of growth of bacteria and mold in the liquid content. Accordingly, it is necessary to adjust the sterilization conditions so that the temperature at the inside and outside surfaces of the neck portion coming into contact with the seal means will be maintained at 61° C. or over.

Temperature at a middle portion between the inside and outside surfaces is also important. When the temperature at this middle portion becomes a temperature exceeding the glass transition temperature determined by moisture content of the container, distortion is caused in the neck portion resulting in poor sealing. It is therefore necessary to adjust the sterilization conditions so that the temperature at the middle portion will not exceed the glass transition temperature determined by moisture content of the container.

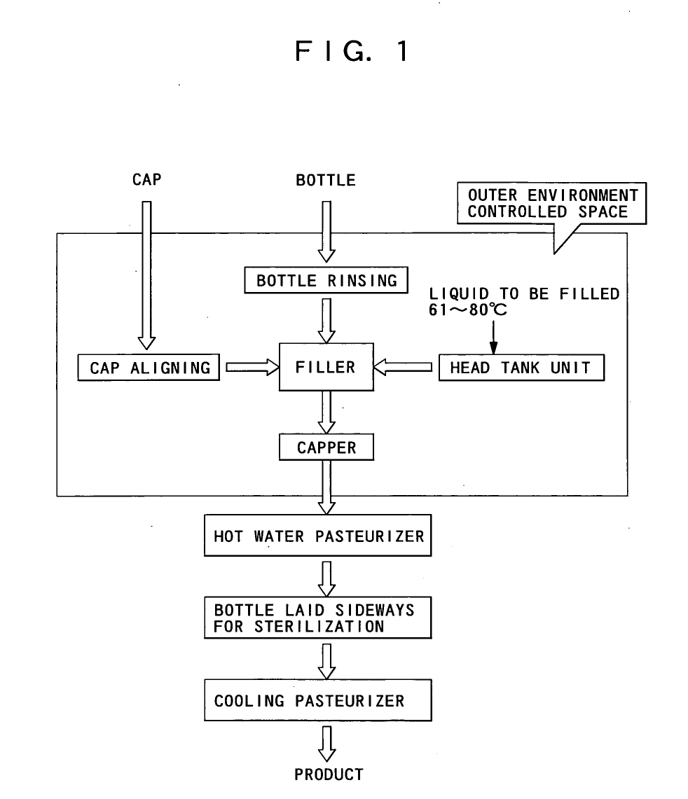

A specific embodiment of the invention applied to a case where drink is filled in a PET bottle having a non-crystallized neck portion will be described with reference to the flow chart of FIG. 1.

In the embodiment of FIG. 1, the bottle is rinsed at least in its inside surface by a bottle rinsing unit disposed in an outer environment controlled space which is controlled at less than Class 100,000. The outer environment controlled space herein means an outside environment such as a working room or a partitioned part of a working room which is controlled in its aseptic condition to a predetermined class or below. In the embodiment shown in FIG. 1, the bottle rinsing unit, filler, head tank unit, cap aligning unit, capper etc. are disposed in the outer environment controlled space.

In the head tank unit, liquid, i.e., contents of the bottle, which is heated to a predetermined temperature within a temperature range which is within 61° C. at the lower limit and 80° C. at the upper limit and less than the glass transition temperature of the bottle determined by the moisture content of the bottle is stored. As the bottle, therefore, a bottle having a glass transition temperature which is below the temperature of the liquid to be filled is selected. The moisture content of the bottle is an important factor which determines the glass transition temperature of the bottle and the smaller the moisture content of the bottle, the higher becomes the glass transition temperature. Therefore, when it is necessary, moisture of the bottle may be removed by, e.g., a dehumidifier before the bottle is rinsed to reduce the moisture content of the bottle.

If the filling temperature is less than 61° C., difficulty arises in achieving sufficient sterilization. On the other hand, in the present invention, a filling temperature exceeding 80° C. is unnecessary for sterilization of the bottle because, if the filling temperature exceeds 80° C., it will be waste of energy and, moreover, it becomes difficult for a PET bottle having a non-crystallized neck portion to have a sufficient heat resisting property. In the present invention, therefore, the lower limit of a preferably filling temperature is 61° C. and the upper limit thereof is 80° C.

The rinsed bottle is transferred to the filler where the liquid stored in the head tank unit is filled in the bottle. Then, a cap which is aligned on a line by the cap aligning unit is attached to the bottle by the capper and the bottle thereby is sealed.

The sealed bottle is transferred to a hot water pasteurizer where the bottle is caused to come into contact in its outer surface with hot water whereby sterilization of the bottle is enhanced.

Then, the bottle is transferred to a bottle laying and sterilizing unit where the bottle is laid sideways for 30 seconds during which the neck portion and the cap portion of the bottle are sterilized by the liquid contained in the bottle.

Then, the bottle is transferred to a cooling pasteurizer where the bottle is cooled to room temperature and thereafter the bottle is delivered out as a product. A known heating pasteurizer may be provided in a prior stage of the cooling pasteurizer so as to perform additional sterilization of the neck and cap portions of the bottle.

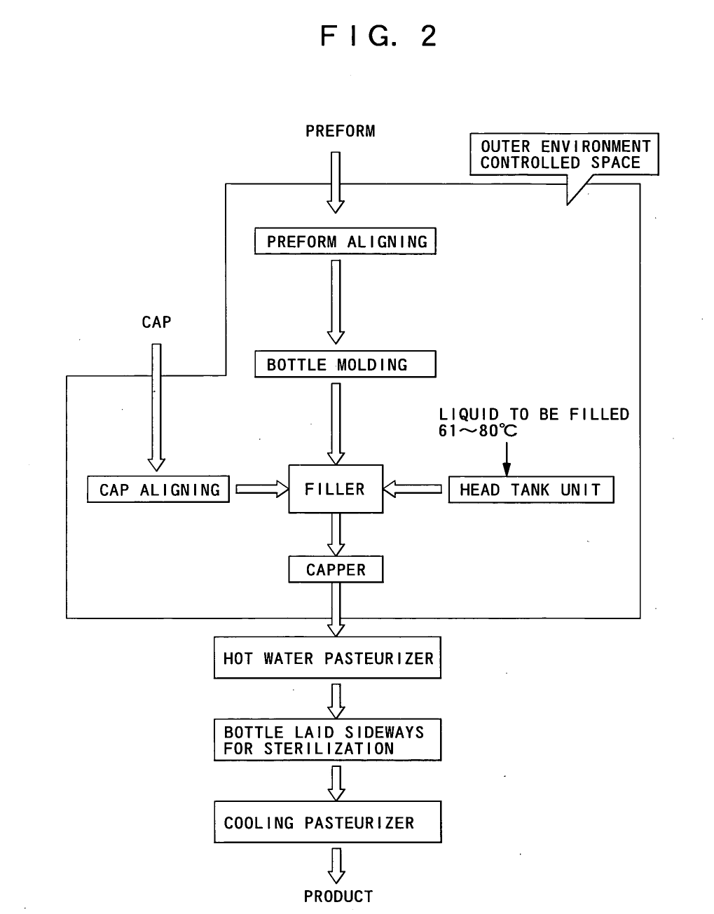

FIG. 2 is a flow chart showing another embodiment of the invention. In this embodiment, the bottle rinsing unit in FIG. 1 is not provided but, instead, a preform aligning unit and a PET bottle forming unit are provided before a filler in an outer environment controlled space.

A preform of a PET bottle is aligned by the preform aligning unit and is transferred one by one to the PET bottle molding unit of the next stage. In the PET bottle molding unit, the preform is molded to a PET bottle having a non-crystallized neck portion. The molded PET bottle is transferred immediately and directly to the filler. Since, in this embodiment, the molded PET bottle is transferred to the filler and liquid is filled immediately after being molded, there is scarcely time for the molded PET bottle to absorb moisture from the outside environment and, therefore, moisture content of the bottle can be reduced by virtue of shortening of time elapsing between molding of the bottle to filling of the liquid into the bottle and glass transition temperature of the bottle can be maintained at a desired high temperature of 80° C. or below. Accordingly, this embodiment is advantageous when it is desired to achieve as high temperature as possible while using a bottle having a non-crystallized neck portion.

Since the steps after filling of the liquid by the filler are the same as the steps of the embodiment shown in FIG. 1, description thereof will be omitted.

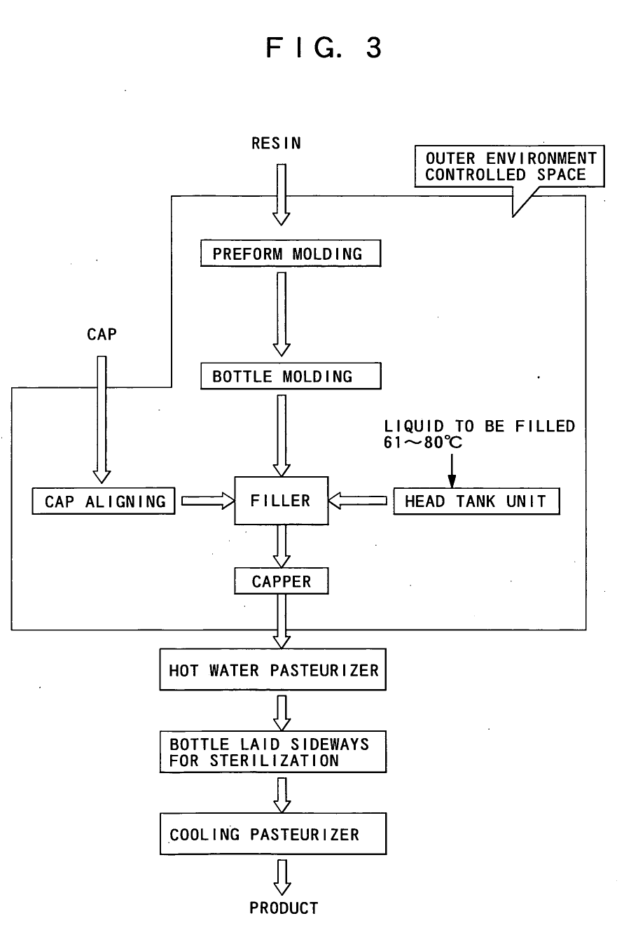

FIG. 3 is a flow chart showing another embodiment of the invention. In this embodiment, the bottle rinsing unit shown in FIG. 1 is not provided but, instead, a preform molding unit and a PET bottle molding unit are provided before the filler in an outer environment controlled space.

In this embodiment, by molding of a preform itself in the outer environment controlled space and transferring the molded preform immediately to the PET bottle molding unit, there is scarcely time for the molded preform to absorb moisture from the outside environment and, therefore, moisture content of the bottle can be reduce further by virtue of shortening of time elapsing between molding of the preform to filling of the liquid into the bottle and glass transition temperature of the bottle can be maintained at a desired further high temperature of 80° C. or below. Since the steps after molding of the bottle are the same as the steps of the embodiment shown in FIG. 2, description thereof will be omitted.

It has been found that, according to the above described embodiments of the invention, by filling liquid in a bottle at a filling temperature within a temperature range of 61° C.-80° C., sufficient drop of internal pressure occurs in a head space of the bottle due to decrease in volume of the liquid after cooling as shown in Example 3 to be described later. In case of a drink contained in a container such as a drink bottled in a PET bottle in which contents of the container are seen from outside, if there is a large head space in a product, it gives to consumers the impression that a sufficient amount of contents is not contained in the container. It is therefore a desire of a manufacturer of a bottled drink to elevate the liquid level of a drink in a bottle to as high a level as possible. Besides, in case of a bottled drink, since the degree of reduction in the internal pressure of a bottle can be recognized by observing the liquid level, the degree of seal of the bottle can be conveniently confirmed by observing the liquid level of the bottle after sealing. According to the above described embodiments, sufficient drop in the internal pressure is produced in the head space of the bottle and, therefore, the liquid level is elevated with the result that consumers are satisfied with the elevated liquid level and the degree of seal of the bottle can be confirmed.

### EXAMPLES

### Example 1

As a specimen of a bottle, 500 ml PET bottles each having a non-crystallized neck portion with a diameter of 28 mm were used. As a specimen of bacterium, Aspergillus niger ATCC6275 which was cultivated for 30 days in a potato dextrose agar medium was used.

Sterilized pure hot water was filled in these bottles at different temperatures shown in the following Table 1. A suspension of spores of the bacterium was added to the bottles at a rate of 10⁶ cfu per bottle and, after capping the bottles, the bottles were laid sideways and held for a predetermined length of time. Then the bottles were cooled by a cooling pasteurizer. The number of the bacterium which remained in each bottle after the cooling step was counted and the effect of sterilization was measured (7 days in the potato dextrose agar medium) and the effect of sterilization was calculated on the basis of log (initial number of bacterium/surviving number of the bacterium). Results are shown in Table 1.

TABLE 1

| | |
|---|---|
| Temperature of | Time (minutes) |

| Sterilization(° C.) | 0.5 | 1 | 2 | 3 |
|---|---|---|---|---|
| 55 | X | X | X | X |
| 60 | X | ◯ | ◯ | ◯ |
| 61 | ◯ | ◯ | ◯ | ⊚ |
| 63 | ◯ | ⊚ | ⊚ | ⊚ |
| 65 | ⊚ | ⊚ | ⊚ | ⊚ |

X: less than 1 D
◯: 1 D - less than 6 D
⊚: 6 D or over

### Example 2

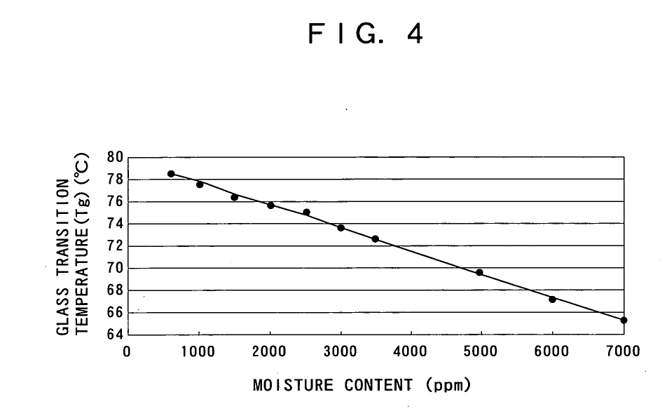

For measuring heat resisting property of the PET bottle having a non-crystallized neck portion, relation between moisture content of non-crystallized neck portion (undrawn portion) and Tg (glass transition temperature, DSC) was calculated and a holding temperature at which the bottle was deformed after filling of a drink in the bottle was regarded as the glass transition temperature and over and the heat resisting property of the bottle was determined from this temperature. Results of the measurement are shown in FIG. 4. From FIG. 4, it will be understood that there is a linear correlation between moisture content of the bottle and the glass transition temperature of the bottle and the smaller the moisture content, the higher becomes the glass transition temperature at the filling temperature of 60-80° C.

### Example 3

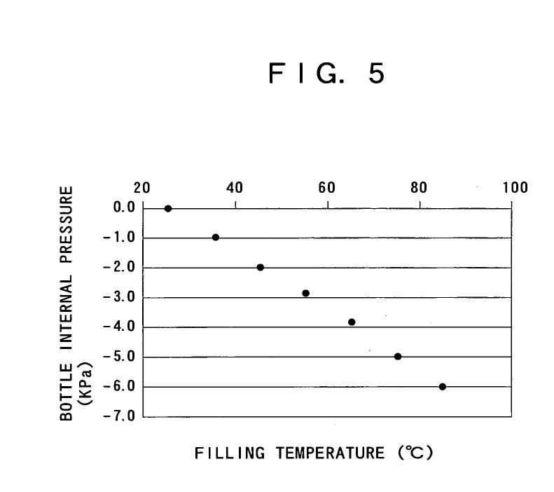

For measuring a state of drop in the internal pressure of the head space of the PET bottle having a non-crystallized neck portion caused by filling of a liquid in the bottle, relation between the filling temperature and the internal pressure of the bottle was measured by using the process shown in FIG. 1. Results of the measurement are shown in FIG. 5. From FIG. 5, it will be understood that internal pressure in the order of −3 KPa to −5 KPa can be obtained.

In sum, according to the present invention, by filling contents in a container at a temperature within a temperature range which is 61° C. or over and less than a glass transition temperature determined by moisture content of the container, and sterilizing the container at this temperature, a commercially sufficient degree of sterilization can be achieved and, therefore, a polyester container having a non-crystallized neck portion whose glass transition temperature is within this temperature range can be used whereby the cost of manufacture of the container can be significantly reduced. Moreover, since the filling temperature can be made substantially lower than the conventional hot-pack, energy consumption can be substantially reduced and time required for cooling after the sterilization can be saved, with the result that production efficiency can be remarkably improved.

There is correlation between glass transition temperature of a container such as a PET bottle and moisture content of the container, i.e., the lower the moisture content of the container, the higher is the glass transition temperature of the container. Therefore, when it is necessary to sterilize the container at a higher temperature to make more sufficient sterilization, it is sometimes necessary to reduce the moisture content of the container so as to increase the glass transition temperature of the container. According to one aspect of the invention, by reducing the moisture content of the container, the glass transition temperature of the container can be increased to exceed a necessary sterilizing temperature.

According to another aspect of the invention, by shortening time from forming of a bottle to filling of contents to the bottle, an amount of moisture which the bottle absorbes from the outside environment is reduced and moisture content of the bottle thereby can be maintained at a lower level.

In performing the method of the present invention, no special apparatus is newly required but an existing apparatus used for manufacturing a bottled drink by the conventional hot-pack can be used without substantial modification and, therefore, the method can be practiced at a low manufacturing cost.

Further, in case contents of the bottle are drinks, there are advantages that drop in the internal pressure of the bottle necessary for elevation of the liquid level of the drinks and confirmation of the degree of seal can be realized at a filling temperature which is lower than the filling temperature by the conventional hot pack.

What is claimed is:

1. A method for manufacturing contents contained in a container by filling the contents in the container, sealing the container and sterilizing the container comprising steps of:
filling the contents in a polyester container having a non-crystallized neck portion;
sealing the container; and
sterilizing the container in such a manner that temperature of the neck portion of the container during sterilization is maintained within a temperature range which is 61° C. or over and less than a glass transition temperature determined by moisture content of the container.

2. A method as defined in claim 1 further comprising a step of cooling the container after sterilization of the container.

3. A method as defined in claim 1 wherein the moisture content of the container is moisture content of the non-crystallized neck portion of the container.

4. A method as defined in claim 1 wherein the filling of the contents in the container and the sealing of the container after the filling are performed in an outer environment controlled space.

5. A method as defined in claim 1 wherein the sterilization of the container is performed by filling heated contents in the container, sealing the container and inclining the container to cause the heated contents to come into contact with neck portion of the container.

6. A method as defined in claim 1 wherein the sterilization of the container is performed by filling the contents in the container, sealing the container and causing hot water to come into contact with outer surface of the container.

7. A method as defined in claim 1 wherein the sterilization of the container is performed by filling the heated contents in the container, sealing the container, and inclining the container to cause the heated contents to come into contact with the neck portion of the container and also causing hot water to come into contact with outer surface of the container.

8. A method as defined in claim 1 further comprising a step of reducing the moisture content of the container before filling the contents in the container.

9. A method as defined in claim 1 further comprising steps of forming a preform of the container, and reducing moisture content of the preform before the preform is formed to the container.

10. A method as defined in claim 1 wherein, after forming of the container, the formed container is transferred directly to the contents filling step.

11. A method as defined in claim 10 wherein the container is formed in an outer environment controlled space.

12. A method as defined in claim 1 further comprising steps of forming a preform of the container, transferring the formed preform directly to a container forming step for forming the preform to the container, and transferring the formed container directly to the contents filling step.

13. A method as defined in claim 12 wherein the steps of forming of the preform, transferring of the preform to the container forming step and forming of the container are performed in an outer environment controlled space.

14. A method as defined in any of claims 4, 11 and 13 wherein the outer environment controlled space is controlled to Class 100,000 or below.

15. A polyester container used in a method as defined in claim 1 having a non-crystallized neck portion and having reduced internal pressure within a range from 0.35 KPa to 0.70 KPa at room temperature and under atmospheric pressure.
